(19) United States
(12) Patent Application Publication
(10) Pub. No.: US 2017/0291412 A1
(43) Pub. Date: Oct. 12, 2017

(54) INKJET HEAD AND INKJET PRINTER

(71) Applicant: TOSHIBA TEC KABUSHIKI KAISHA, Tokyo (JP)

(72) Inventor: Manabu AKIMOTO, Mishima Shizuoka (JP)

(21) Appl. No.: 15/427,849

(22) Filed: Feb. 8, 2017

(30) Foreign Application Priority Data
Apr. 7, 2016 (JP) 2016-077289

(51) Int. Cl. B41J 2/045

(52) U.S. Cl. CPC B41J 2/04541; B41J 2/04586

(57) ABSTRACT

An inkjet head includes a head unit, a storage unit, an identification circuit, and a driving control circuit. The head unit ejects ink. The storage unit stores print data. The identification circuit identifies a type of a head unit. The driving control circuit transmits the print data in an order corresponding to a type of the head unit which is identified by the identification circuit.

### CROSS-REFERENCE TO RELATED APPLICATION

This application is based upon and claims the benefit of priority from Japanese Patent Application No. 2016-077289, filed Apr. 7, 2016, the entire contents of which are incorporated herein by reference.

### FIELD

Embodiments described herein relate generally to an inkjet head and an inkjet printer.

### BACKGROUND

A controller of an inkjet head performs a control process according to an interface specification of a head unit. Data transmission to the head unit is different depending on a type of the head unit, and it is necessary for the controller to perform data transmission according to the type of the head unit.

A controller can include a reconfigurable circuit, which executes data transmission in accordance with a head unit. However, it is necessary for the controller including the reconfigurable circuit to reconfigure the circuit in software, which increases complexity.

### DESCRIPTION OF THE DRAWINGS

FIG. 1 is a block diagram illustrating an example of a printing system according to one embodiment.

FIG. 2 is a block diagram illustrating an example of an inkjet head according to an embodiment.

FIG. 3 is a diagram illustrating an example of data stored in a memory according to an embodiment.

FIG. 4 is a circuit diagram illustrating an example of an identification circuit according to an embodiment.

FIG. 5 is a block diagram illustrating an example of a driving control circuit according to an embodiment.

FIG. 6 is a block diagram illustrating an example of a print data transmission control circuit according to an embodiment.

### DETAILED DESCRIPTION

An exemplary embodiment provides an inkjet head and an inkjet printer that perform data transmission in accordance with a head unit.

In general, according to one embodiment, the inkjet head includes a head unit, a storage unit, an identification circuit, and a driving control circuit. The head unit ejects ink. The storage unit stores print data. The identification circuit identifies a type of a head unit. The driving control circuit transmits the print data in an order corresponding to a type of the head unit which is identified by the identification circuit.

Hereinafter, an embodiment will be described with reference to drawings.

A printing system according to an embodiment forms an image on a printing medium by ejecting ink onto the printing medium (for example, a sheet). For example, the printing system forms a predetermined image on the printing medium according to an operation by an operator.

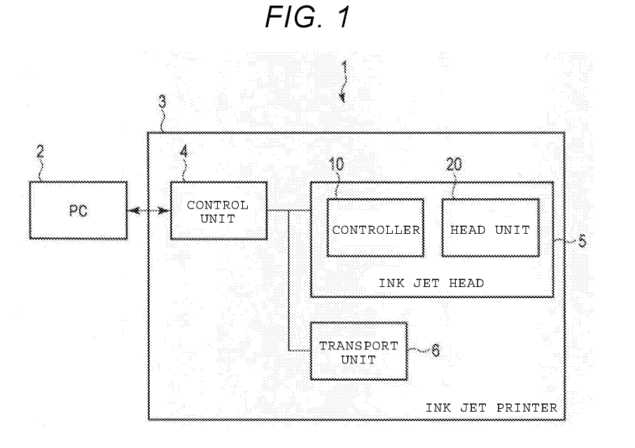

FIG. 1 is a block diagram illustrating an example of a printing system 1 according to an embodiment.

As illustrated in FIG. 1, the printing system 1 comprises a personal computer (PC) 2 and an inkjet printer 3.

The PC 2 transmits image data to be formed on a printing medium to an inkjet head 5. For example, the PC 2 comprises an operation unit, which receives as input an operation from an operator. The PC 2 transmits image data to the inkjet head 5 according to an operation that is input through the operation unit.

The PC 2 is, for example, a desktop PC, a notebook PC, a tablet PC, or the like.

The inkjet printer 3 forms an image on a printing medium (for example, a sheet) by ejecting ink stored in an ink cartridge onto the printing medium.

As illustrated in FIG. 1, the inkjet printer 3 comprises a control unit 4, the inkjet head 5, and a transport unit 6.

The control unit 4 has a function of controlling operations of the entire inkjet printer 3. The control unit 4 comprises, for example, a central processing unit (CPU), a read-only memory (ROM), a random access memory (RAM), a non-volatile memory (NVM), and the like or any combination thereof. The control unit 4 performs various processing by executing a program that is stored in advance in an internal memory, such as a ROM, an NVM, or the like.

The inkjet head 5 ejects ink onto a printing medium based on a signal from the control unit 4. The inkjet head 5 is described below.

The transport unit 6 transports a printing medium on a predetermined transport path based on the signal from the control unit 4. For example, the transport unit 6 comprises a table that fixes the printing medium thereto in an adsorbing manner, a driving unit that transports the table, and the like. The transport unit 6 transports the table using the driving unit, and transports the printing medium fixed to the table in the adsorbing manner.

Subsequently, the inkjet head 5 will be described.

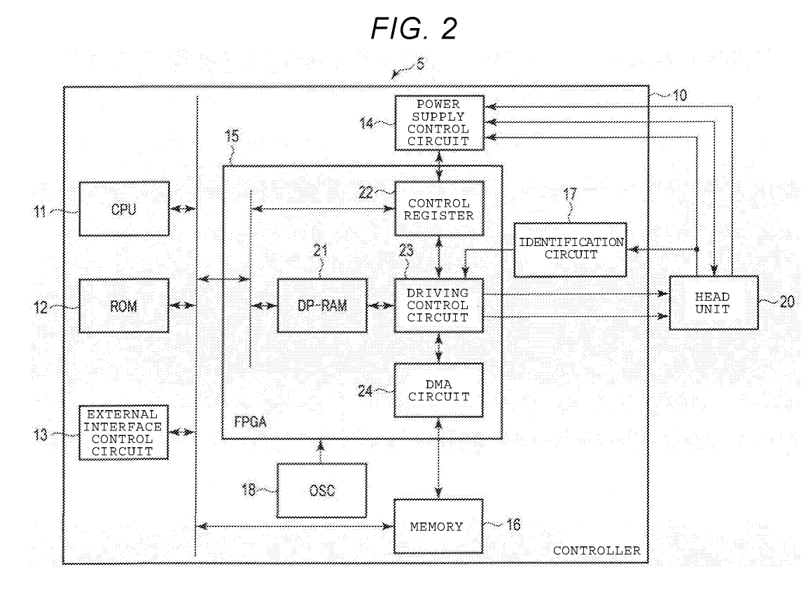

FIG. 2 is a block diagram illustrating an example of the inkjet head 5.

As illustrated in FIG. 2, the inkjet head 5 comprises a controller 10 and a head unit 20.

The controller 10 drives the head unit 20 based on the signal from the control unit 4. For example, the controller 10 generates a driving signal by driving the head unit 20 based on the signal from the control unit 4. The controller 10 drives the head unit 20 by outputting the generated driving signal to the head unit 20. The controller 10 comprises, for example, an integrated circuit (IC), or the like.

The head unit 20 ejects ink onto a printing medium based on the driving signal from the controller 10. The head unit 20 is a head of a sharing mode in which a wall surface that forms an ink chamber is shared between ink chambers. Here, the head unit 20 is a head in which a plurality of ink chambers are divided into three divisions, and ink is ejected from each division (first division, second division, and third division) in order.

For example, the head unit 20 comprises an ink chamber that stores ink, a driving circuit that drives a wall surface of the ink chamber, and the like. The ink chamber is connected to the ink cartridge, and ink is supplied from the ink cartridge. The driving circuit applies a voltage to the ink chamber so that a predetermined image is formed according to a driving signal. The wall surface of the ink chamber is formed of a piezoelectric element, and is driven according to a voltage which is output from the driving circuit. A volume in the inside of the ink chamber is changed due to driving of the wall surface. The head unit 20 ejects ink that is stored inside onto a printing medium from an ejecting hole when a volume of the ink chamber is changed.

As illustrated in FIG. 2, the controller 10 comprises the CPU 11, the ROM 12, an external interface control circuit 13, a power supply control circuit 14, a field programmable gate array (FPGA) 15, a memory 16 (storage unit), an identification circuit 17 (identification unit), and an oscillator (OSC) 18. The CPU 11 communicates with the ROM 12, the external interface control circuit 13, the power supply control circuit 14, the FPGA 15, the memory 16, and the identification circuit 17 through a bus, or the like. The FPGA 15 comprises a dual port (DP)-RAM 21, a control register 22, a driving control circuit 23 (driving control unit), and a direct memory access (DMA) circuit 24.

The CPU 11 has a function of controlling operations of the entire controller 10. The CPU 11 may include an internal cache, various interfaces, and the like. The CPU 11 executes various processing by executing a program (code) stored in advance in the internal memory, such as the ROM 12, or the NVM (not illustrated). The CPU 11 is, for example, a processor.

In addition, a part of various functions described as being executed by the CPU 11 can be implemented using a hardware circuit. In this case, the CPU 11 controls a function that is implemented by the hardware circuit.

The ROM 12 is a non-volatile memory in which a control program, control data, and the like, are stored in advance. The control program and the control data that are stored in the ROM 12 are incorporated according to a specification of the controller 10 in advance. The ROM 12 stores, for example, a program (for example, a basic input/output system (BIOS)), or the like, which controls a circuit board of the controller 10.

The external interface control circuit 13 controls an interface for transmitting and receiving data to and from an external device, based on a signal from the CPU 11.

The power supply control circuit 14 controls power supplied to the head unit 20 based on a control signal from the FPGA 15, a head status from the head unit 20, and the like. For example, the power supply control circuit 14 obtains a temperature, or the like, of the head unit 20 as the head status. The power supply control circuit 14 controls a voltage, or the like, which is supplied to the head unit 20 based on the control signal, the head status, and the like.

The FPGA 15 controls the power supply control circuit 14, the head unit 20, and the like, based on a signal, or the like, from the CPU 11.

The memory 16 stores print data. For example, the memory 16 stores print data on a line-by-line basis. In addition, the memory 16 stores print data on a division-by-division basis. For example, in a case in which the head unit 20 ejects ink in three divisions, the memory 16 stores first division transmission data, second division transmission data, and third division transmission data on the line-by-line basis. The first division transmission data is print data for ejecting ink from the first division. The second division transmission data is print data for ejecting ink from the second division. The third division transmission data is print data for ejecting ink from the third division.

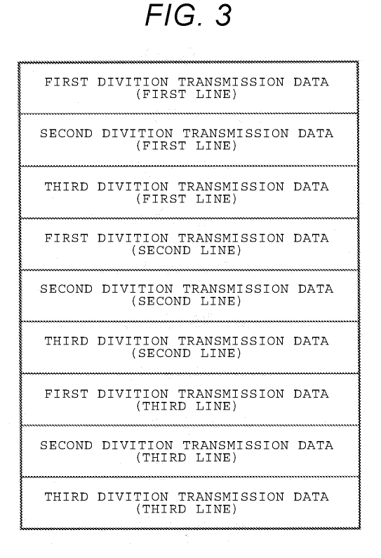

FIG. 3 illustrates an example of print data stored in the memory 16.

As illustrated in FIG. 3, the memory 16 stores print data on the line-by-line basis. That is, the memory 16 stores print data of the first line, print data of the second line, and print data of the third line.

In addition, the memory 16 stores three division transmission data on the line-by-line basis. For example, the memory 16 stores the first division transmission data, the second division transmission data, and the third division transmission data as print data of the first line.

The driving control circuit 23 may store a head pointer in which print data of each line is stored.

The identification circuit 17 identifies a type of the head unit 20, and supplies a bit corresponding to the type to the driving control circuit 23. A configuration of the identification circuit 17 is described below.

The OSC (oscillator, or the like) 18 supplies a source signal for supplying a clock to the head unit 20 and to the FPGA 15.

The DP-RAM 21 stores data to be transmitted to the driving control circuit 23 from the CPU 11, or the like.

The control register 22 temporarily stores data that is necessary for the driving control circuit 23 to execute processing.

The driving control circuit 23 transmits a driving signal to the head unit 20 according to print data, or the like. The driving control circuit 23 is described below.

The DMA circuit 24 obtains print data from the memory 16 based on a signal from the driving control circuit 23, or the like. The DMA circuit 24 transmits the obtained print data to the driving control circuit 23.

Subsequently, the identification circuit 17 will be described.

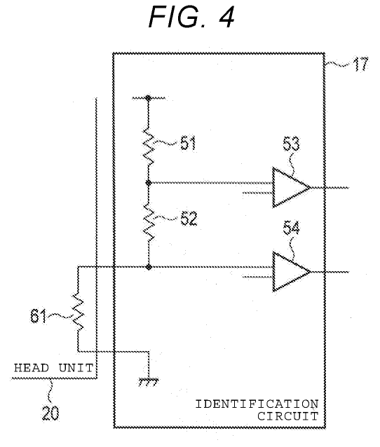

FIG. 4 is a circuit diagram illustrating an example of the identification circuit 17 according to an embodiment.

As illustrated in FIG. 4, the identification circuit 17 comprises resistors 51 and 52, and comparators 53 and 54. In addition, here, the head unit 20 includes a resistor 61.

One end of the resistor 51 is connected to a predetermined voltage. The other end of the resistor 51 is connected to one input terminal of the comparator 53. A predetermined reference voltage is input to the other input terminal of the comparator 53.

The other end of the resistor 51 is connected to one end of the resistor 52. The other end of the resistor 52 is connected to one input terminal of the comparator 54. A predetermined reference voltage is input to the other input terminal of the comparator 54.

The other end of the resistor 52 is connected to one end of the resistor 61. The other end of the resistor 61 is connected to electrical ground (GND).

The comparator 53 compares voltages that are input to two input terminals, and outputs a predetermined voltage from an output terminal based on a comparison result. That is, the comparator 53 compares voltages between the resistors 51 and 52 and a predetermined reference voltage, and outputs a predetermined voltage from the output terminal based on the comparison result.

The comparator 54 compares voltages between the resistors 52 and 61 and a predetermined reference voltage, and outputs a predetermined voltage from the output terminal based on the comparison result.

Outputs from the comparators 53 and 54 are input to the driving control circuit 23 as head identification bits that denote a type of the head unit 20.

The resistor 61 is formed inside the head unit 20. A resistance value of the resistor 61 is uniquely determined according to a type of the head unit 20. That is, the resistance value of the resistor 61 denotes a type of the head unit 20.

Subsequently, example operation of the identification circuit 17 will be described.

The comparator 53 compares a voltage that is divided in the resistors 51 and 52, and the resistor 61 to a predetermined reference voltage. The comparator 53 outputs High when the divided voltage is larger than the predetermined reference voltage. In addition, the comparator 53 outputs Low when the divided voltage is smaller than the predetermined reference voltage.

The comparator 54 compares a voltage divided in the resistors 51 and 52, and the resistor 61 to a predetermined reference voltage. The comparator 54 outputs High when the divided voltage is larger than the predetermined reference voltage. In addition, the comparator 54 outputs Low when the divided voltage is smaller than the predetermined reference voltage.

As a result, the comparators 53 and 54 output a bit in accordance with a resistance value of the resistor 61. That is, the comparators 53 and 54 output a bit (head identification bit) that denotes a type of the head unit 20.

In addition, the identification circuit 17 can prevent an erroneous insertion or a connection failure of the head unit 20 by using two comparators.

Subsequently, the driving control circuit 23 will be described.

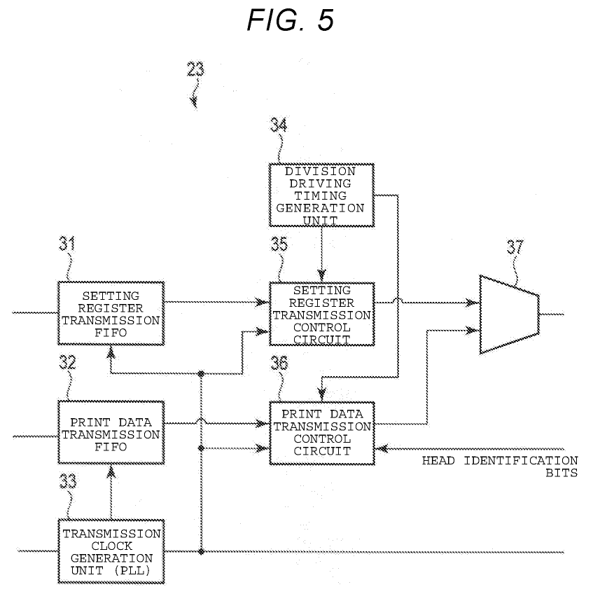

FIG. 5 is a block diagram illustrating an example of the driving control circuit 23 according to an embodiment.

As illustrated in FIG. 5, the driving control circuit comprises a setting register transmission first-in-first-out circuit (FIFO) 31, a print data transmission FIFO 32, a transmission clock generation unit 33, a division driving timing generation unit 34, a setting register transmission control circuit 35, a print data transmission control circuit 36, and a selector 37.

The setting register transmission FIFO 31 receives setting data from the DP-RAM 21, the control register 22, or the like, and stores the received setting data. The setting register transmission FIFO 31 transmits stored setting data to the setting register transmission control circuit 35 in order of reception.

The print data transmission FIFO 32 receives print data from the DMA circuit 24, or the like, and stores the received print data. The print data transmission FIFO 32 transmits stored print setting data to the print data transmission control circuit 36 in order of reception.

The transmission clock generation unit 33 generates a clock signal that is used for transmitting data to the head unit 20, or the like. The transmission clock generation unit 33 receives a source signal from the external OSC (oscillator, or the like) 18, and generates a clock signal based on the source signal. The transmission clock generation unit 33 supplies the generated clock signal to the setting register transmission FIFO 31, the print data transmission FIFO 32, the setting register transmission control circuit 35, the print data transmission control circuit 36, and the like.

The division driving timing generation unit 34 generates a timing for transmitting setting data or print data for each division. The division driving timing generation unit 34 transmits a timing signal for notifying of a timing to other blocks.

For example, the division driving timing generation unit 34 determines a timing by generating pulse, or the like, at a predetermined interval. The division driving timing generation unit 34 notifies other blocks of a timing by transmitting the generated pulse to other blocks as a timing signal.

The division driving timing generation unit 34 transmits a timing signal to the setting register transmission control circuit 35, the print data transmission control circuit 36, and the like.

The setting register transmission control circuit 35 transmits setting data received from the setting register transmission FIFO 31 to the selector 37. The setting register transmission control circuit 35 transmits setting data to the selector 37 according to a timing signal received from the division driving timing generation unit 34.

The print data transmission control circuit 36 transmits print data received from the print data transmission FIFO 32 to the selector 37. The print data transmission control circuit 36 transmits print data to the selector 37 according to a timing signal received from the division driving timing generation unit 34.

The print data transmission control circuit 36 is described below.

The selector 37 selectively outputs data from the setting register transmission control circuit 35 or the print data transmission control circuit 36 to the head unit 20 based on a signal from other blocks. For example, the selector 37 outputs setting data from the setting register transmission control circuit 35 to the head unit 20 at a desirable transmission timing. In addition, the selector 37 outputs print data from the print data transmission control circuit 36 to the head unit 20 at a desirable transmission timing.

Subsequently, the print data transmission control circuit 36 will be described.

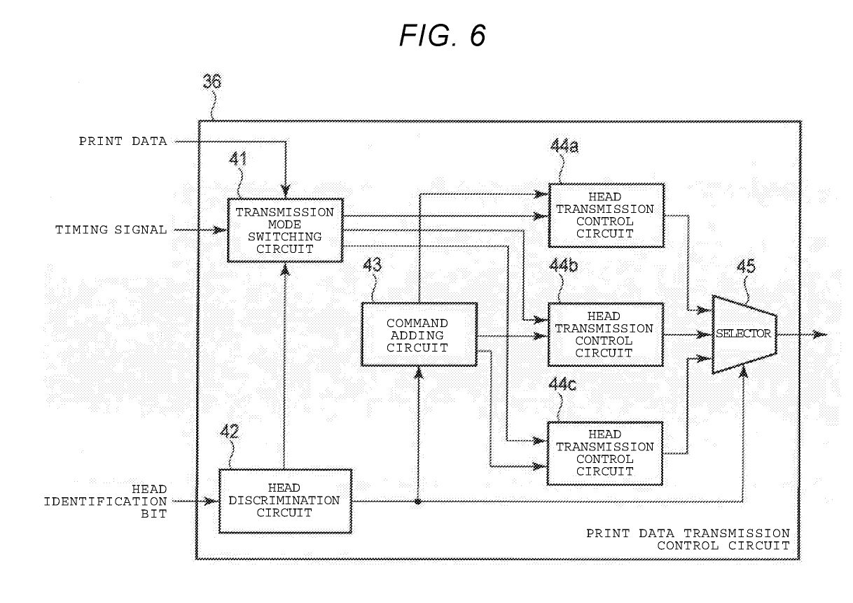

FIG. 6 is a block diagram illustrating an example of the print data transmission control circuit 36 according to an embodiment.

As illustrated in FIG. 6, the print data transmission control circuit 36 comprises the transmission mode switching circuit 41, the head discrimination circuit 42, the command adding circuit 43, the head transmission control circuit 44 (44a to 44c) (transmission unit), and the selector 45.

The transmission mode switching circuit 41 receives an identification signal that denotes a type of the head unit 20 from the head discrimination circuit 42, and switches a transmission mode for transmitting print data to the head unit 20 from the memory 16 based on the identification signal. That is, the transmission mode switching circuit 41 sets an order of transmitting print data using the print data transmission control circuit 36 according to a type of the head unit 20.

For example, the transmission mode switching circuit 41 switches an order of print data to be stored in the head transmission control circuit 44. For example, the transmission mode switching circuit 41 stores the first division transmission data, the second division transmission data, and the third division transmission data in the head transmission control circuits 44a to 44c in order on the line-by-line basis, as one transmission mode. That is, the transmission mode switching circuit 41 stores the first division transmission data of the first line in the head transmission control circuit 44a, the second division transmission data of the first line in the head transmission control circuit 44b, and the third division transmission data of the first line in the head transmission control circuit 44c. In addition, the transmission mode switching circuit 41 stores each of the division transmission data of the second line in the head transmission control circuits 44a to 44c, when printing of the first line is finished.

In addition, the transmission mode switching circuit 41 stores the first division transmission data of each line in the head transmission control circuits 44a to 44c in order, as one transmission mode. That is, the transmission mode switching circuit 41 stores the first division transmission data of the first line in the head transmission control circuit 44a, the first division transmission data of the second line in the head transmission control circuit 44b, and the first division transmission data of the third line in the head transmission control circuit 44c. In addition, the transmission mode switching circuit 41 stores the first division transmission data of the fourth line and thereafter in the head transmission control circuits 44a to 44c when printing in the first division transmission data from the first line to the third line is finished. The transmission mode switching circuit 41 stores the second division transmission data of each line in the head transmission control circuits 44a to 44c when printing in the first division transmission data of each line is finished.

The transmission mode switching circuit 41 transmits print data to the head transmission control circuit 44 based on a timing signal.

In addition, for example, the transmission mode switching circuit 41 may transmit a signal to the DMA circuit 24, and designate print data to be read from the memory 16.

The head discrimination circuit 42 transmits an identification signal that denotes a type of the head unit 20 to the transmission mode switching circuit 41, the command adding circuit 43, and the selector 45 based on a head identification bit. For example, the head discrimination circuit 42 may generate an identification signal corresponding to the head identification bit, and transmit the identification signal to the transmission mode switching circuit 41, the command adding circuit 43, and the selector 45. In addition, the head discrimination circuit 42 may transmit the head identification bit to the transmission mode switching circuit 41, the command adding circuit 43, and the selector 45 as an identification signal.

The command adding circuit 43 transmits a command to the head transmission control circuits 44a to 44c based on the identification signal from the head discrimination circuit 42. For example, the command adding circuit 43 determines a command in accordance with the identification signal, and supplies the command in accordance with the identification signal to the head transmission control circuits 44a to 44c.

The head transmission control circuit 44 (44a to 44c) stores print data, or the like, to be transmitted to the head unit 20. That is, the head transmission control circuit 44 stores print data which is supplied from the transmission mode switching circuit 41. In addition, the head transmission control circuit 44 adds a command supplied from the command adding circuit 43 to print data. For example, the head transmission control circuit 44 adds a command to a head of print data, and stores the print data to which the command is added.

The head transmission control circuit 44 transmits the print data to which the command is added to the selector 45.

The selector 45 transmits data that is transmitted from the head transmission control circuits 44a to 44c (print data to which command is added) to the head unit 20. For example, the selector 45 outputs data transmitted from the head transmission control circuits 44a, 44b and 44c to the head unit 20 in order.

In addition, the selector 45 may determine an order of outputting data from the head transmission control circuit 44 to the head unit 20 based on the identification signal from the head discrimination circuit 42.

Subsequently, an operation example of the inkjet head 5 will be described.

Here, it is assumed that the memory 16 stores print data.

First, the identification circuit 17 generates a head identification bit based on the resistor 61 of the head unit 20, and transmits the head identification bit to the driving control circuit 23.

The head discrimination circuit 42 of the print data transmission control circuit 36 in the driving control circuit 23 receives a head identification bit. When receiving the head identification bit, the head discrimination circuit 42 generates an identification signal based on the head identification bit, and transmits the head identification bit to the transmission mode switching circuit 41, the command adding circuit 43, and the selector 45.

The transmission mode switching circuit 41 receives the identification signal. When receiving the identification signal, the transmission mode switching circuit 41 sets a transmission mode corresponding to the identification signal. When setting the transmission mode, the transmission mode switching circuit 41 stores print data in the head transmission control circuit 44 according to the transmission mode. For example, the transmission mode switching circuit 41 obtains print data from the DMA circuit 24 in a predetermined order, and transmits the print data to the head transmission control circuit 44 in order.

The head transmission control circuit 44 stores the print data from the transmission mode switching circuit 41.

The command adding circuit receives an identification signal. When receiving the identification signal, the command adding circuit 43 transmits a command in accordance with the identification signal to the head transmission control circuit 44. The head transmission control circuit 44 gives a command to the print data.

When each of the head transmission control circuits 44 gives a command to print data, the selector 45 supplies data from one of the head transmission control circuit 44 (for example, head transmission control circuit 44a) to the head unit 20 at a predetermined timing. When the selector 45 supplies data from one of the head transmission control circuits 44 to the head unit 20, the head unit 20 receives the data from the one of the head transmission control circuits 44. The head unit 20 ejects ink onto a printing medium from a predetermined division, based on a command and print data included in the received data.

The selector 45 supplies data from another head transmission control circuit 44 (for example, head transmission control circuit 44b) to the head unit 20 in order at a predetermined timing. When the selector 45 supplies data from another head transmission control circuit of the head transmission control circuit 44 to the head unit 20, the head unit 20 receives the data from said another head transmission control circuit of the head transmission control circuit 44.

The head unit 20 ejects ink onto a printing medium from a predetermined division based on a command and print data included in the received data.

The print data transmission control circuit 36 transmits a command and print data to the head unit 20 by repeating the above described operation. In addition, the transmission mode switching circuit 41 stores the subsequent print data in the head transmission control circuit 44 in which transmission of data is finished. In addition, the command adding circuit 43 stores a command in the head transmission control circuit 44.

The CPU 11 may store print data in the memory 16 after the identification circuit 17 outputs a head identification bit. In addition, the command adding circuit 43 may store a command in the head transmission control circuit 44, before the head transmission control circuit 44 stores print data.

The inkjet head configured in this manner can generate ahead identification bit that denotes a type of the head unit. The inkjet head sets an order of transmitting print data to the head unit, based on the head identification bit. The inkjet head gives a command to print data based on a head identification bit. As a result, the inkjet head can appropriately transmit a command and print data to the head unit according to a type of the head unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope of the inventions.

What is claimed is:

1. An inkjet head, comprising:
a head unit configured to eject ink;
a storage unit configured to store print data;
an identification circuit configured to identify a type of the head unit; and
a driving control circuit configured to transmit the print data in an order corresponding to a type of the head unit that is identified by the identification circuit.

2. The inkjet head according to claim 1,
wherein the driving control circuit includes a plurality of transmission circuits configured to transmit data to the head unit, the driving control circuit configured to store the print data in the plurality of transmission circuits.

3. The inkjet head according to claim 1,
wherein the driving control circuit is configured to provide a command in accordance with the type of the head unit that is identified by the identification circuit to the print data.

4. The inkjet head according to claim 1,
wherein the driving control circuit is configured to set an order of transmitting division transmission data for each division of the head unit to the head unit in each line, as the print data.

5. The inkjet head of claim 1, wherein the identification circuit comprises:
a first resistor coupled between a predetermined voltage and a first node;
a second resistor coupled between the first node and a second node;
a first comparator having a first input coupled to the first node, a second input coupled a first predetermined reference voltage, and an output coupled to the driving control circuit; and
a second comparator having a first input coupled to the second node, second input coupled to a second predetermined reference voltage, and an output coupled to the driving control circuit.

6. The inkjet head of claim 5, wherein the head unit includes a third resistor coupled between the second node and an electrical ground.

7. The inkjet head of claim 1, wherein the driving control circuit comprises:
a setting register transmission control circuit configured to receive setting data;
a print data transmission control circuit configured to receive the print data;
a first selector configured to selectively transmit an output of the setting register transmission control circuit or the print data transmission control circuit to the head unit.

8. The inkjet head of claim 7, wherein the driving control circuit further comprises:
a division driving timing generation unit configured to transmit a timing signal to the setting register transmission control circuit and the print data transmission control circuit.

9. The inkjet head of claim 7, wherein the print data transmission control circuit comprises:
a head discrimination circuit configured to generate an identification signal based on output of the identification circuit; and
a transmission mode switching circuit configured to switch a transmission mode for transmitting the print data based on the identification signal.

10. The inkjet head of claim 9, wherein the print data transmission control circuit further comprises:
a plurality of head transmission control circuits configured to receive the print data from the transmission mode switching circuit; and
a second selector configured to select among outputs of the plurality of head transmission control circuits based on the identification signal.

11. An inkjet printer, comprising:
an inkjet head, comprising:
a head unit configured to eject ink;
a storage unit configured to store print data;
an identification circuit configured to identify a type of the head unit; and
a driving control circuit configured to transmit the print data in an order corresponding to a type of the head unit that is identified by the identification circuit; and
a transport unit configured to transport a printing medium on which an image is formed with the ink.

12. The inkjet printer according to claim 11,
wherein the driving control circuit includes a plurality of transmission circuits configured to transmit data to the head unit, the driving control circuit configured to store the print data in the plurality of transmission circuits.

13. The inkjet printer according to claim 11,
wherein the driving control circuit is configured to provide a command in accordance with the type of the head unit that is identified by the identification circuit to the print data.

14. The inkjet printer according to claim 11,
wherein the driving control circuit is configured to set an order of transmitting division transmission data for each division of the head unit to the head unit in each line, as the print data.

15. The inkjet printer of claim 11, wherein the identification circuit comprises:
a first resistor coupled between a predetermined voltage and a first node;
a second resistor coupled between the first node and a second node;
a first comparator having a first input coupled to the first node, a second input coupled a first predetermined reference voltage, and an output coupled to the driving control circuit; and
a second comparator having a first input coupled to the second node, second input coupled to a second predetermined reference voltage, and an output coupled to the driving control circuit.

16. The inkjet printer of claim 15, wherein the head unit includes a third resistor coupled between the second node and an electrical ground.

17. The inkjet printer of claim 11, wherein the driving control circuit comprises:
a setting register transmission control circuit configured to receive setting data;
a print data transmission control circuit configured to receive the print data;
a first selector configured to selectively transmit an output of the setting register transmission control circuit or the print data transmission control circuit to the head unit.

18. The inkjet printer of claim 17, wherein the driving control circuit further comprises:
a division driving timing generation unit configured to transmit a timing signal to the setting register transmission control circuit and the print data transmission control circuit.

19. The inkjet printer of claim 17, wherein the print data transmission control circuit comprises:
a head discrimination circuit configured to generate an identification signal based on output of the identification circuit; and
a transmission mode switching circuit configured to switch a transmission mode for transmitting the print data based on the identification signal.

20. The inkjet printer of claim 19, wherein the print data transmission control circuit further comprises:
a plurality of head transmission control circuits configured to receive the print data from the transmission mode switching circuit; and
a second selector configured to select among outputs of the plurality of head transmission control circuits based on the identification signal.
